(19) United States
(12) Patent Application Publication
(10) Pub. No.: US 2025/0223054 A1
(43) Pub. Date: Jul. 10, 2025

(54) ENVELOPE, SYSTEM AND METHOD FOR PROTECTING A PORTION OF AN AIRCRAFT BODY

(71) Applicant: Diden Boris YOUKANA, Saint Forgeux (FR)

(72) Inventor: Diden Boris YOUKANA, Saint Forgeux (FR)

(21) Appl. No.: 18/848,011

(22) PCT Filed: Mar. 17, 2023
(86) PCT No.: PCT/EP2023/056854

§ 371 Date: Sep. 17, 2024

(30) Foreign Application Priority Data
Mar. 17, 2022 (FR) 2202364

(51) Int. Cl. B64F 1/00

(52) U.S. Cl. CPC B64F 1/005

(57) ABSTRACT

A protective envelope for a portion of an aircraft body, including a framework and a fabric, the fabric being mechanically coupled to the framework and extending around the framework so that, in a deployed configuration of the envelope, the framework enables holding of the fabric, the framework being configured so as to be located between the portion of the aircraft body and an inner face of the fabric while keeping the fabric at a distance from the portion of the aircraft body, the framework including at least one duct adapted to be filled with a fluid, so that when the conduit is filled with a fluid the envelope automatically deploys so that the fabric at least partially covers the portion of the aircraft body.

### TECHNICAL FIELD

The present invention relates to the protection of a portion of an aircraft body.

### PRIOR ART

There are currently systems for protecting the wings, the engines and the empennage of aircraft against dust or cold. For example, mention may be made of the patent application CN1966351 which discloses a coating for protecting against dust and cold for the wings and the engines of an aircraft. The coating comprises several sections connected together by cables in order to adapt the dimensions of the coating to that of the wings and of the engines. Yet, the coating is long to implement in order to hold the sections together.

Mention may also be made of the French patent application FR3057253, which discloses a protective slipcover intended to cover the external envelope of an aircraft to limit the risks of freezing. The slipcover is formed by different patterns, the pieces of which are intended to be arranged around the envelope, and then mutually assembled by sewing. The slipcover internally comprises a network of perforated sheaths connected to an air-conditioning unit, so that the network of perforated sheaths could diffuse conditioned air over the surface of the envelope in order to regulate the temperature and the hygrometry of the aircraft being stored. Yet, positioning of the slipcover is difficult because the slipcover could be torn at the seams connecting the patterns. The set-up of the slipcover is also long to implement. Moreover, this system is particularly complex.

Furthermore, the British patent application GB1527802 discloses a method for protecting an aircraft with several sheets of plastic film, comprising welding the overlapping parts of the sheets to form an airtight envelope around at least part of the aircraft, evacuating the air from the envelope and encircling the sheets with adhesive tape to hold them in position. Such a protective system is long and complex to implement.

Mention may also be made of the patent application GB2331972, which discloses a system comprising wing envelopes and the patent applications WO2018/014973 and US2002/023390 which disclose temporary shelters.

An object of the invention is to overcome these drawbacks, and more particularly to provide means for protecting a portion of an aircraft body that are simple to make and to implement, in particular for a rapid implementation time.

### SUMMARY

To achieve this objective, a protective envelope for a portion of an aircraft body is provided, comprising a framework and a fabric, the fabric being mechanically coupled to the framework and extending around the framework so that, in a deployed configuration of the envelope, the framework enables holding of the fabric, preferably tensioning of the fabric, the framework being configured so as to be located between the portion of the aircraft body and an inner face of the fabric so that the fabric could at least partially cover the portion of the aircraft body while keeping the fabric at a distance from the portion of the aircraft body, the framework comprising at least one duct adapted to be filled with a fluid, so that when the conduit is filled with a fluid the envelope deploys so that the fabric at least partially covers the portion of the aircraft body.

Thus, a protective means that is rapid to implement is provided. In particular, it could be installed by non-technician personnel. For example, by a pilot or crew member. Furthermore, it is ensured that the inner face of the fabric is effectively kept at a distance from the portion of the aircraft body so as to protect the fabric from any tears that might occur by friction against the portion of the body during deployment of the envelope. Advantageously, the fabric is kept tensioned in the deployed configuration to improve the protection of the aircraft portion from external projectiles that could damage the aircraft. Such an envelope allows avoiding elements projected in the direction of the aircraft hitting its wall and damaging it. So is the case, for example, of projection of hail, gravel, branches or screws that might be present on the airfield and projected by the wheels of the aircraft or by movements of air due to strong wind gusts. Indeed, in the context of the development of the present invention, it has been noticed that the projection of this type of elements on the walls of an aircraft is largely responsible for ageing of the latter. Such an envelope is particularly suitable for protecting an aircraft against impacts. Such an envelope offers a protection that is robust and simple to set up.

According to another aspect, a protective system is proposed for a portion of an aircraft body, comprising an envelope as defined hereinbefore, and a deployment system comprising a compression system and a connector, said at least one duct of the envelope comprising an inlet orifice able to be connected to the deployment system, the connector being configured to transmit a fluid from an outlet of the compression system up to the inlet orifice so as to fill said at least one duct with the fluid.

Thus, the user does not need to deploy the envelope around the aircraft portion by himself/herself. Such a system is particularly suitable for automating the deployment of the protective envelope. According to another aspect, an assembly is provided comprising an aircraft and an envelope as defined hereinbefore. The probe projects from the wall of the aircraft. When the envelope deploys, the fabric does not abut against the probe. Moreover, thanks the framework, when the fabric is deployed, it is kept at a distance from the probe. Thus, the risks of tearing of the fabric by the probe are avoided. Preferably, the thickness of the framework is larger than the height of the probe. The height of the probe is measured according to a direction perpendicular to the tangent to the wall of the aircraft at a base of the probe. The thickness of the framework is measured according to this same direction. This allows facilitating protection of the aircraft, irrespective of the equipment that this aircraft is equipped with.

According to another aspect, a method is provided for protecting a portion of an aircraft body, comprising providing an envelope as defined hereinbefore, and deploying the envelope so that the fabric of the envelope at least partially covers the portion of the aircraft body, the deployment comprising filling at least one duct of the framework with a fluid.

According to another aspect, the invention relates to a protective envelope for a portion of an aircraft body, comprising an framework and a fabric, the fabric being mechanically coupled to the framework and extending around the framework so that, in a deployed configuration of the envelope, the framework enables holding of the fabric, preferably tensioning of the fabric, the framework being configured so as to be located between the portion of the aircraft body and an inner face of the fabric so that the fabric could at least partially cover the portion of the aircraft body while keeping the fabric at a distance from the portion of the aircraft body. The envelope comprising at least one sensor configured to collect measurements as well as a transmission device configured to transmit data relating to these measurements to a remote terminal. For example, this transmission is performed via a communication network, for example a data communication network. Thus, the envelope is a communicating envelope.

According to one embodiment, the sensor is selected from among: an impact sensor, for example an accelerometer, a pressure sensor, a humidity or hygrometry sensor, a position sensor, preferably using a satellite positioning system (for example GPS® or Galileo®).

Preferably, the envelope is configured so that the transmission device transmits the data when the measurements exceed a predetermined threshold.

In the particularly advantageous case of an impact sensor, the envelope may send to the remote user information informing the latter of a possible degradation of the aircraft by projection of an object. For example, it may consist of a branch or a bolt propelled on the aircraft by the wind or by passage of another aircraft. In this case, the user can therefore schedule a maintenance of his/her aircraft, without disturbing his/her flight plan. Thus, the invention allows considerably facilitating the use of aircraft.

### BRIEF DESCRIPTION OF THE FIGURES

The aims, objects, as well as the features and advantages of the invention will appear better from the detailed description of some embodiments and implementations of the latter, illustrated by the following appended drawings, wherein:

FIG. 1 schematically illustrates a perspective view of an aircraft according to the prior art;

FIG. 2 schematically illustrates a perspective view of an aircraft and of an embodiment of a protective system according to the invention;

FIG. 3 schematically illustrates a perspective view of the aircraft and of another embodiment of the protective system;

FIG. 4 schematically illustrates another perspective view of the aircraft and of the protective system of FIG. 2;

FIG. 5 schematically illustrates a perspective view of an embodiment of a protective envelope according to the invention;

FIG. 6 schematically illustrates a perspective view of another embodiment of a protective envelope; and

FIG. 7 schematically illustrates a sectional view of another embodiment of a protective envelope.

The drawings are given as examples and do not limit the invention. They consist of schematic representations of principle intended to facilitate understanding of the invention and are not necessarily plotted to the scale of practical applications.

### DETAILED DESCRIPTION

Before starting a detailed review of embodiments of the invention, optional features are listed hereinafter, which could possibly be used in combination or alternatively. According to one example,
said at least one duct includes a fluid-tight hollow body.
According to one example, the envelope comprises a plurality of ducts forming a network of branched ducts.
According to one example, several ducts are fluidly connected to one another.
According to one example, the framework comprises at least one inlet orifice configured to be connected to a deployment system, the deployment system being configured to supply the framework with fluid.
According to one example, the framework forms at least one ring, said at least one ring being configured to at least partially surround the portion of the aircraft body when the framework is deployed.
According to one example, at least one ring is configured to clasp the portion of the aircraft body when the framework is deployed.
According to one example, said at least one ring is located at least at one of the ends of the envelope.
According to one example, at least one ring has an outer surface having at least one part forming, according to a section of said at least one ring, a completely closed continuous contour. Such a ring enables an initial positioning of part of the fabric around the portion of the aircraft body before deployment of the envelope. Furthermore, such a ring facilitates the deployment of the envelope according to a generatrix perpendicular to a section of the ring.
According to one example, the framework forms at least two rings, each of said at least two rings being configured to surround, at least partially, the portion of the aircraft body when the framework is deployed.
According to one example, the framework forms at least two rings each having a continuous contour.
According to another example, the framework forms at least two rings, one amongst the two rings having a continuous contour and the other one amongst the two rings having an interrupted contour to form an opening. According to one example, this opening interrupts the continuity of the ring. According to one example, this opening is carried by the ring located at the distal end of the envelope. According to one example, this opening is configured to enable the deployment of the fabric when the ring encounters an obstacle such as a landing gear.
According to one example, this opening is directed opposite the ground when the framework is deployed.
According to one example, at least part of the fabric forms, at least according to a section, a completely closed contour.
According to one example, the fabric comprises a transparent area. A user can see through this transparent area. This area is configured so as to let part of the optical radiation in the visible spectrum pass through.
According to one example, the deployment system further comprises an envelope configured to be fluidly connected to the connector and to the inlet orifice of said at least one duct.
According to one example, the case is configured to accommodate the envelope when the envelope is in a retracted configuration.
According to one example, the case is configured to be mechanically coupled to the envelope when the envelope is in the deployed configuration.
According to one example, the compression system includes an electromechanical compressor. Typically, it consists of a compressor supplied with electric power which allows pressurising a fluid such as air so as to inject it into the framework. This system offers particularly improved ease and speed of use. Alternatively, the compression system is a manual system. Thus, this system is configured to be actuated by the user. For example, it comprises a pump allowing pressurising the fluid in order to inject it into the framework. This system is particularly inexpensive and lightweight.
According to one example, the envelope is configured so as to be supported by a portion of the aircraft body that the fabric covers at least partially when the envelope is in the deployed configuration.
According to one example, the assembly comprises a protective system as defined hereinbefore.
According to one example, the aircraft comprises at least one probe, for example a pressure probe, and the envelope is configured so that, when the duct is filled with a fluid, the fabric of the envelope deploys without interfering with the probe.
According to one example, in the deployed configuration, the fabric is configured to cover at least 50% of the portion of the aircraft body.
According to one example, in the deployed configuration, the fabric is kept at a distance from the portion of the aircraft body comprised between 5 cm and 50 cm.
According to one example, the portion corresponds to a cockpit of an aircraft.
According to one example, the portion corresponds to a wing of an aircraft.
According to one example, the fabric comprises a transparent area intended to be located at the level of a windshield of the aircraft.
According to one example, the deployment of the protective envelope is automated.
According to one example, the deployment of the protective envelope comprises an extension of the framework according to a generatrix.

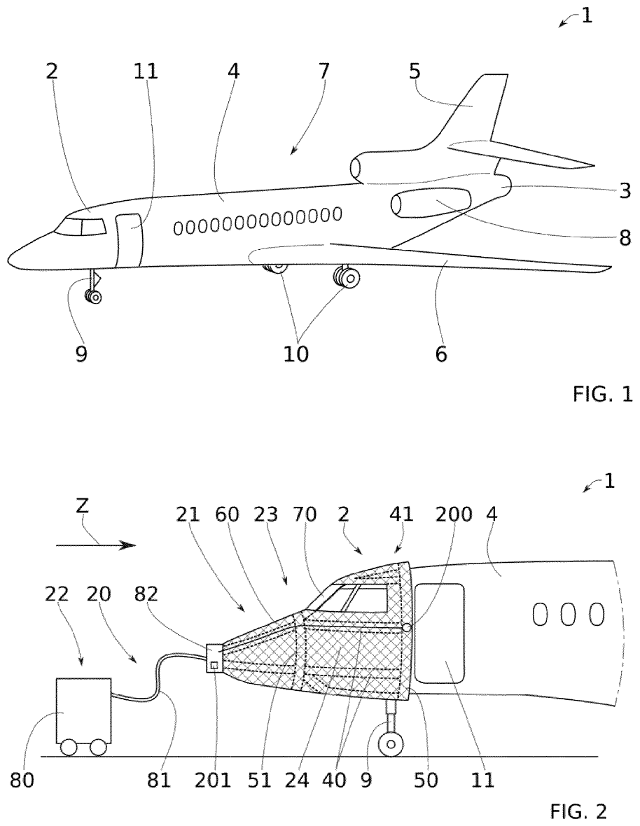

FIG. 1 shows an aircraft 1 according to the prior art. In general, an aircraft 1 includes a body having several portions 2 to 7, in particular a cockpit 2, a tail 3, a fuselage 4 connecting the cockpit 2 to the tail 3, an empennage 5 and two left and right wings 6, 7. Furthermore, the aircraft 1 comprises other equipment mounted on the aircraft body 1, in particular like engines 8, front 9 and rear 10 landing gears, and access doors 11.

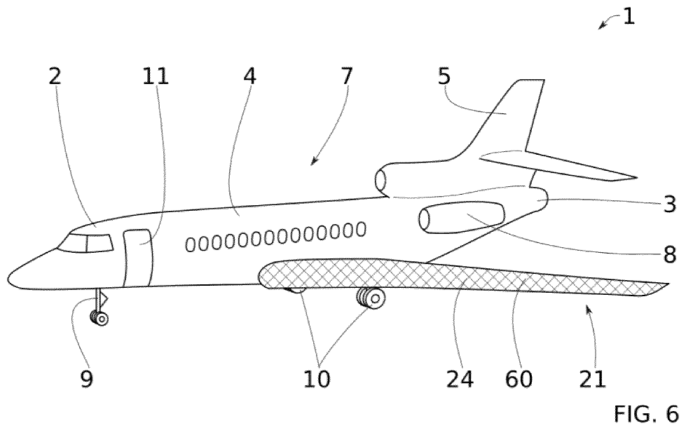

FIG. 2 shows the cockpit 2 of the aircraft body 1 and a protective system 20. The protective system 20 includes an envelope 21, so-called protection envelope, and a deployment system 22. In FIGS. 2 to 7, different embodiments of the protective envelope 21 have been shown. The envelope 21 is intended to protect a portion 2 to 7 of the aircraft body 1. For example, in FIGS. 2 to 4, an envelope 21 is shown adapted to protect the cockpit 2 of the aircraft body 1 and, in FIG. 6, an envelope adapted to protect a wing 6, 7 of the aircraft body 1. In general, the envelope 21 is intended to protect a portion 2 to 7 of the aircraft body 1 against dust and more particularly against small-sized solids that could damage the aircraft body, such as rain, hail, leaves and twigs or maintenance parts, for example screws, nails, steel or plastic pads, small-sized maintenance tools, like screwdrivers, hammers, etc.

The cover 21 includes a framework 23 and a fabric 24. The fabric 24 is mechanically coupled to the framework 23. For example, the fabric 24 may be sewn, glued or fused by heating or by ultrasounds. The fabric 24 may be made of fabric or a plastic material, or a combination of both.

In other words, the fabric 24 is foldable. More particularly, the fabric 24 is coupled to the framework 23 so that, in a deployed configuration of the envelope 21, the framework 23 allows holding the fabric 24. Thus, the fabric 24 conforms to the shape imposed by the framework 23. Preferably, the fabric 24 is coupled to the framework 23 so that, in a deployed configuration of the envelope 21, the framework 23 allows tensioning the fabric 24. Preferably, in the retracted configuration of the framework 23, the fabric 24 could be folded, or fold under the effect of its own weight. In the deployed configuration of the framework 23, the fabric 24 no longer forms folds, in particular in the absence of an external stress.

The fabric 24 may comprise several fabric parts assembled together by sewing, gluing or heat fusion. Preferably, the fabric 24 is made of one single fabric part. Advantageously, the fabric 24 is liquid-tight to improve the protection of the aircraft 1. For example, the fabric 24 has a puncture resistance equal to about 800 J/m2 (the puncture tests are carried out with a point having a diameter of 0.8 mm). In other words, the fabric 24 has a puncture resistance because of external elements having a diameter comprised between 4 and 4.9 cm, a mass of about 30, 49 g, a drop speed of about 27.4 m/s and a kinetic energy of about 11.5 J. The fabric 24 has a generally parallelepiped shape. The fabric 24 includes an outer face 25, visible in FIGS. 2 to 6, an inner face 26 opposite to the outer face 25 and not visible in FIGS. 2 to 6 and four lateral faces 27 to 30. Furthermore, the fabric 24 has a thickness much smaller than the dimensions of the outer 25 and inner 26 faces. Preferably, the fabric 24 is solid, i.e. it does not include closed cavities, such as cells, or a through-cavity over one of its main lengths X, Y. When the fabric 24 is solid, it does not include a space located between the outer face 25 and the inner face 26 and opening onto two lateral faces. Furthermore, when the fabric 24 is solid, it may include micro-cavities, i.e. through orifices across the thickness of the fabric 24, or blind orifices over its outer 25, inner 26 or lateral 27 to 30 faces.

Moreover, the framework 23 is configured so as to be located between the portion 2 to 7 of the aircraft body 1 and an inner face 26 of the fabric 24 so that the fabric 24 at least partially covers the portion 2 to 7 of the aircraft body. In other words, the framework 23 is intended to be placed in contact with the portion 2 to 7 of the aircraft body 1. More particularly, the framework 23 is configured so as to keep the fabric at a distance from the portion 2 to 7 of the aircraft body 1.

According to one example, the framework 23 is configured to keep the fabric 24 at a distance from the portion 2 to 7 of the aircraft body 1 comprised between 5 cm and 50 cm. Preferably, the distance is comprised between 10 cm and 50 cm, and even more preferably between 15 cm and 50 cm. Indeed, if the distance is strictly larger than 50 cm, there is a risk of the envelope 21 not being deployed properly and the fabric 24 not being kept tensioned properly. If the distance is strictly smaller than 5 cm, there is a risk of the fabric 24 not passing over some projecting pieces of equipment of the body of the aircraft 1, such as probes, for example pressure probes such as Pitot probes or antennas, and there is also a risk of the envelope 21 not being deployed properly. Hence, the fabric 24 is located at a distance from the portion 2 to 7, in other words the fabric 24 is not in contact with the portion 2 to 7 it covers at least partially.

In general, the envelope 21 is configured to be deployed. This means that the envelope 21 could occupy a retracted position, in which the framework 23 and the fabric 24 are retracted, in other words, the framework 23 and the fabric 24 are folded over themselves, and a deployed position in which the framework 23 and the fabric 24 are deployed so that the fabric 24 at least partially covers a portion 2 to 7 of the aircraft body 1 to protect the portion 2 to 7. In the retracted position, the envelope 21 does not protect the portion 2 to 7 of the aircraft body 1.

The framework 23 comprises at least one duct 40. For example, the ducts may have a cylindrical shape. By cylindrical, it should be understood a surface generated by a straight line passing through a closed curve parallel to a straight line so-called generatrix. In particular, the ducts have a hollow body. The ducts 40 are further configured to be filled with a fluid, preferably under pressure. More particularly, the ducts 40 have a fluid-tight body so as to maintain the fluid contained therein under pressure in order to be able to keep the fabric 24 tensioned. In particular, the shock waves of the impacts may be absorbed by the fabric 24 kept tensioned and by the deformation of the framework 23. The fluid may be a gas, for example air, or a liquid, for example water. Furthermore, the ducts 40 are configured so that, when the ducts 40 are filled with the fluid, the envelope 21 deploys so that the fabric 24 at least partially covers the portion 2 to 7 of the aircraft body 1. In other words, the framework 23 is an inflatable structure. Thus, the envelope 21 switches from the retracted position into the deployed position by filling the duct(s) 40 of the framework 23 of the fluid. In particular, the ducts 40 form an area intended to be placed in contact with the portion 2 to 7 of the aircraft body 1. In other words, the ducts 40 form a structure for supporting the ducts 40 when the fluid fills the ducts 40. In general, the framework 23 includes a first part, so-called the outer part, in contact with the fabric 24 and a second part, so-called the inner part, intended to be placed in contact with the portion 2 to 7 of the aircraft body 1. When the fluid fills the ducts 40, the framework 23 generates a space between the portion 2 to 7 of the aircraft body 1 and the inner face 26 of the fabric 24, to keep the fabric 24 at a distance from the portion 2 to 7. The ducts 40 may be made of textile. For example, the ducts 40 may comprise over their inner wall a polyurethane thermoplastic membrane to guarantee tightness to air, and also to the liquid, to maintain an inflation pressure inside the ducts 40.

Preferably, the distance separating the aircraft portion and the fabric 24 corresponds to a thickness of the framework 23, or more specifically to the thickness of a duct 40 of the framework 23. The thickness of the framework 23 is measured according to a direction perpendicular to the tangent to the wall of the aircraft at the considered point. If the duct 40 has a circular periphery, then the thickness of the framework 23 corresponds to the outer diameter of the duct 40.

More particularly, the fabric 24 is configured to cover at least 50% of the portion 2 to 7 of the aircraft body 1. Preferably, the fabric 24 is configured to cover 80% of the portion 2 to 7, or 100% of the portion 2 to 7.

According to one embodiment, the framework 23 comprises a plurality of ducts 40 forming a network 41 of branched ducts 40. For example, the framework 23 comprises several ducts 40 fluidly connected to one another. In general, the framework 23 comprises at least one inlet orifice 42 configured to let the filling fluid pass through the duct(s) 40.

Advantageously, the inlet orifice(s) 42 are configured to connect to the deployment system 22, the deployment system 22 being configured to supply the framework 23 with fluid. Thus, a deployment of the automated envelope 21 is provided by inflation of the framework 23. A deployment of the envelope 21 by inflation allows adapting the envelope 21 to the geometry of a portion 2 to 7 of the aircraft body 1.

According to another advantage, the framework 23 forms at least one ring 50, 51, configured to at least partially surround the portion 2 to 7 of the aircraft body 1. Preferably, a ring 50, 51 is configured to surround more than 50%, and even more preferably more than 75% of the portion 2 to 7 of the aircraft body 1. A ring 50, 51 is configured to clasp the portion 2 to 7 of the aircraft body 1.

For example, a ring 50, so-called end ring, is configured to be located at least at one of the ends of the envelope 21. The end ring 50 allows avoiding wind infiltrating inside the envelope 21.

Advantageously, the framework 23 forms at least two rings 50, 51, each configured to clasp, at least partially, the portion 2 to 7 of the aircraft body 1.

A ring 51 is located at a proximal end of the envelope. The proximal end is configured to cover the end of the portion of the aircraft body 1 from which the envelope 21 is deployed. The distal end is located opposite the envelope 21 with respect to the proximal end. As illustrated in FIG. 5, the ring of the proximal end is referenced 51 and the ring of the distal end is referenced 50.

According to another advantage, at least one ring 50, 51 has an outer surface having at least one part forming, according to a section of said at least one ring 50, 51, a completely closed continuous contour. Such a ring 50, 51 enables an initial positioning of a part of the fabric 24 around the portion 2 to 7 of the aircraft body 1 before deployment of the envelope 21. Furthermore, such a ring 50, 51 facilitates the deployment of the envelope 21 according to a generatrix Z perpendicular to a section of the ring 50, 51. For example, at least one ring 50, 51 is formed in one-piece. In other words, at least one ring 50, 51 delimits one single pocket, i.e. one single space intended to receive the fluid to inflate said at least one ring 50, 51. In particular, a ring 50, 51 formed in one-piece is distinct from an arc-shaped duct the two ends of which can approach each other until coming into contact to form a partially closed discontinuous contour. The completely closed continuous contour is configured to clasp the portion 2 to 7 of the aircraft body 1 when the framework 23 is deployed. By a ring 50, 51 configured to clasp the portion 2 to 7 of the aircraft body 1, it should be understood the fact that the ring 50, 51 entirely surrounds the portion 2 to 7 of the aircraft body 1. It is also said that the ring 50, 51 has a completely closed continuous contour around the portion 2 to 7 of the aircraft 1. In general, by clasping, it should be understood completely surrounding a section of the portion 2 to 7 of the aircraft 1.

In general, at least one ring 50, 51 has an outer surface having a portion configured to be in contact, at least partially, and preferably entirely, with the portion 2 to 7 of the aircraft body 1, when the framework 23 is deployed. Thus, said at least one ring 50, 51 prevents wind from infiltrating between the fabric 24 and the portion 2 to 7 of the aircraft body 1. This advantage is even more beneficial when the user is positioning the envelope 21. Thus, the envelope 21 is much easier to install than other solutions wherein the user should make several parts cooperate together to cover the portion 2 to 7 of the aircraft body 1. Indeed, in the context of the development of the present invention, it has turned out that with a solution based on an envelope formed of several portions which cooperate together, these different portions offer, during handling thereof, a strong wind intake, which makes the installation very difficult to the user. According to one example, the portion of the outer surface of at least one ring 50, 51 is configured to be in contact with at least 25% of the outer surface of a section of the portion 2 to 7 of the aircraft body 1, for example between 25% and 75%, preferably at least 75%, and more preferably entirely. The section of the portion 2 to 7 of the aircraft body 1 being considered in a plane containing a ring 50, 51 when the envelope 21 is deployed. The section corresponding to the part of the portion 2 to 7 of the aircraft body 1 surrounded by said at least one ring 50, 51.

For example, if a ring 50, 51 surrounds a wing or a nose of the aircraft 1, the ring 50, 51 is in contact, over at least 25% and preferably at least 75% of the length of the periphery of the section of the wing or of the section of the nose, this section being considered in a plane containing the ring 50, 51.

The ring 50, 51 may be closed, or not.

According to one example, it is closed. According to another example, it is open, for example so that the ring 50, 51 does not encounter an obstacle such as a landing gear, during the deployment of the envelope. In this case, the ring has an opening. This opening is smaller than 25% of the circumference of the ring 50, 51.

More preferably, the distal end ring 51 has an outer surface having a portion configured to be entirely in contact, with the portion 2 to 7 of the aircraft body 1, when the framework 23 is deployed. Thus, it is guaranteed that the wind does not infiltrate between the portion of the outer surface of the end ring 51 and the portion 2 to 7 of the aircraft body 1. According to another advantage, each ring 50, 51 has an outer surface having a portion configured to be entirely in contact, with the portion 2 to 7 of the aircraft body 1, when the framework 23 is deployed.

According to still another advantage, the framework 23 has an outer surface having a portion configured to be in contact at least partially, preferably entirely, with the portion 2 to 7 of the aircraft body 1, when the framework 23 is deployed, so as to prevent wind from infiltrating between the portion of the outer surface of the framework 23 and the portion 2 to 7 of the aircraft body 1. In other words, the portion of the outer surface of the framework 23 is configured to be in contact with at least 25% of the outer surface of the portion 2 to 7 of the aircraft body 1, for example between 25% and 75%, preferably at least 75%, and more preferably entirely.

According to another advantage, the portion of the outer surface of the framework 23 enables the envelope 21 to be supported by the portion 2 to 7 of the aircraft body 1. Preferably, the envelope 21 is configured so as to be supported by the portion 2 to 7 of the aircraft body 1 that the fabric 24 covers at least partially when the envelope 21 is deployed. Thus, the envelope 21 is not in direct contact with the ground. Thus, the envelope 21 is the closest to the aircraft 1, and enables a movement of the aircraft 1 with the envelope 21 deployed, for example during a taxiing phase. Furthermore, this enables the envelope 21 being located at a distance from the ground, which avoids degradations of the envelope 21 by the projections of gravel and fluids flowing on the ground.

In general, the envelope 21, in the deployed configuration, forms a sleeve configured to cover the portion 2 to 7 of the aircraft body 1. For example, the sleeve formed by the envelope 21 fits over a wing or over the nose of the aircraft. For example, such a sleeve allows an initial filling of the ducts 40 with the fluid, then a positioning of the envelope 21 so that the envelope 21 at least partially covers the portion 2 to 7 of the aircraft body 1. For example, the initial filling may comprise a complete filling of the ducts 40 so as to form the sleeve. For example, the initial filling may be performed when the envelope 21 is located at a distance from the portion 2 to 7 of the aircraft body 1.

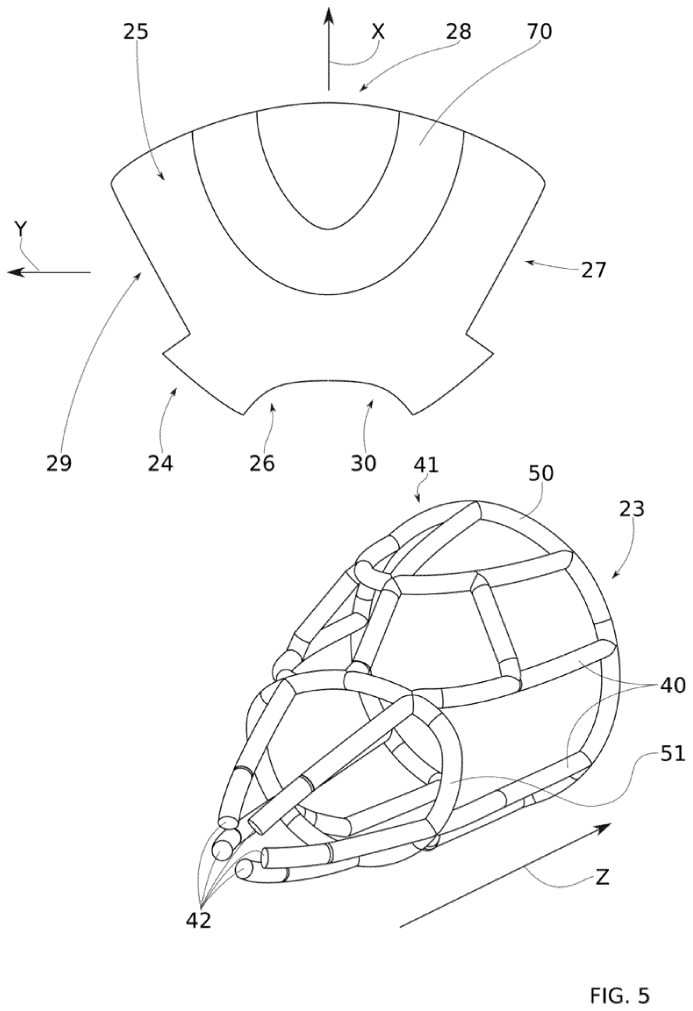

The fabric 24 may comprise at least one portion 60 forming, at least according to a section of the fabric 24, a completely closed contour. Advantageously, the fabric 24 is configured to leave an opening 90 for the passage of the front landing gear 9, as illustrated in FIG. 4.

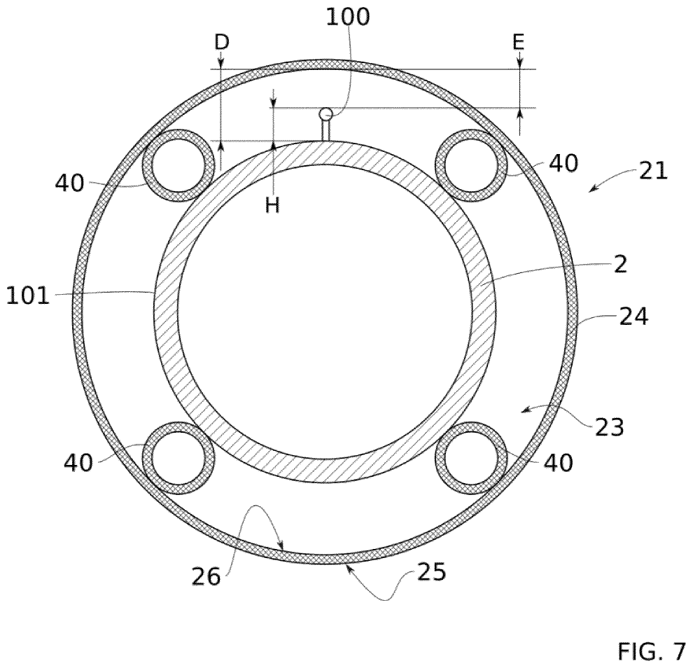

In FIG. 7, the envelope 21 has been shown in its deployed configuration. Furthermore, the portion 2 to 7 of the aircraft body 1 corresponds to the cockpit 2 of the aircraft 1. In the deployed configuration, the framework 23 is in its deployed configuration, in other words, the ducts 40 are filled with the fluid and are inflated. Furthermore, the fabric 24 is kept, preferably under tension, in particular the fabric 24 is kept at a distance d from the cockpit 2. This means that the inner face 26 of the fabric 24 is located at the distance D from an outer surface 101 of the cockpit 2. The aircraft 1 may comprise at least one probe 100, for example a pressure probe. Furthermore, the envelope 21 is configured so that, when the duct 40 is filled with a fluid, the fabric 24 of the envelope 21 deploys without interfering with the probe 100. The probe 100 projects from a wall of the aircraft 1, in particular from the outer surface 101 of the wall of the aircraft 1. When the envelope 21 deploys, the fabric 24 does not abut against the probe 100. Moreover, when the fabric 24 is deployed, it is kept, thanks to the framework 23, at a distance from the probe 100. More particularly, the probe 100 has a height H, and it is provided that the thickness of the framework 23 is strictly larger than the height H. Thus, the risks of tearing of the fabric 24 by the probe 100 are avoided. Preferably, the thickness of the framework 23 is larger than the height of the probe. The height of the probe is measured according to a direction perpendicular to the tangent to the wall of the aircraft at a base of the probe. The thickness of the framework 23 is measured according to this same direction. This allows facilitating the protection of the aircraft 1, irrespective of the equipment that this aircraft 1 is equipped with. According to another embodiment, the fabric 24 comprises at least one transparent area 70. A user can see through this transparent area. By transparent, it should be understood an area that allows transmitting at least 70% of a luminous flux whose wavelengths are included in the visible spectrum. This transparent area is intended to be located at the level of a windshield of the aircraft 1, and more particularly at the level of a windscreen of the cockpit 2 of the aircraft body 1. This enables a pilot of the aircraft 1 to move the aircraft 1 on the ground while the fabric 24 partially covers the cockpit 2, typically during a taxiing phase.

FIG. 2 shows an automated deployment mode of the envelope 21. The deployment system 22 comprises a compression system 80 and a connector 81. The connector 81 is configured to be connected to at least one inlet orifice 42 of the framework 23. The connector 81 is further configured to transmit a fluid, stored in the compression system 80, from an outlet of the compression system 80 up to the inlet orifices 42 so as to fill the duct(s) 40 with the fluid. The compression system 80 may comprise an electromechanical compressor. Typically, it consists of a compressor supplied with electric power which allows pressurising a fluid such as air so as to inject it into the framework 23. Such an electromechanical compressor is particularly inexpensive and lightweight. Thus, the compression system 80 has a particularly improved ease and speed of use. Alternatively, the compression system 80 is a manual system. Thus, this system is configured to be actuated by the user. For example, it comprises a pump allowing pressurising the fluid in order to inject it into the framework 23. This compression system 80 is particularly inexpensive and lightweight.

Moreover, the deployment system may further comprise an envelope 82 configured to be fluidly connected to the connector 80 and to the inlet orifices 42 of the duct(s) 40. The envelope 82 is configured to accommodate the envelope 21 when the envelope 21 is in a retracted configuration.

The envelope 82 is configured to be mechanically coupled to the envelope 21 when the envelope 21 is in the deployed configuration. Thus, the envelope 82 remains connected to the envelope 21 when the latter is deployed over the portion 2 to 7 of the aircraft body 1. This allows having a standalone complete system associated with the envelope 21. Thus, the risk of loss of some elements of the system 22 is reduced. Furthermore, the compression system 80 may be integrated into the case 82. Alternatively, the compression system 80 may be removable, for example mounted on a movable vehicle which is moved from one aircraft to another, or mounted on a power supply network connected to the hangar or to the aerodrome reserved for aircraft traffic and parking.

Advantageously, the protective system 20 comprises a pressure sensor 200, as illustrated in FIG. 2, configured to measure a pressure of the fluid filling the ducts 40 of the framework 23. For example, the pressure sensor 200 may be mounted on the case 82 and comprise a pressure detection unit located inside a duct 40 of the framework 23. Preferably, the detection unit is located inside the end ring 50. For example, the pressure sensor 200 is electrically coupled, through a wired connection, to an electronic control device 201 of the case 82. The electronic control device 201 may comprise a processor or a micro-processor. The electronic control device 201 is configured to control the compression system 80 in order to inject the fluid into the ducts 40 of the framework 23 with a desired pressure. According to another example, the pressure sensor 200 is connected, through a wireless link, to the electronic control device 201.

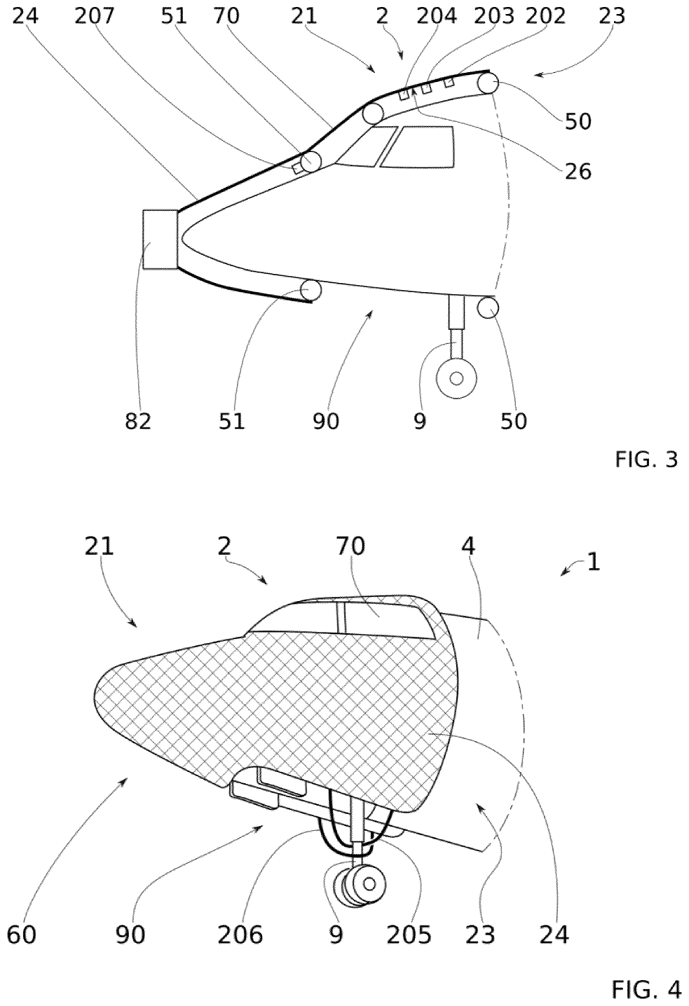

According to still another advantage, the envelope 21 may comprise an additional pressure sensor 202, as illustrated in FIG. 3, configured to measure an air pressure within the space located between the fabric 24 and the aircraft body 1. The envelope 21 may also comprise a hygrometry sensor 203 configured to measure the hygrometry between the fabric 24 and the aircraft body 1. Preferably, the additional pressure sensor 202 and the hygrometry sensor 203 are mounted on the inner face 26 of the fabric 24. These two sensors 202, 203 may be provided with a wireless transmission device to remotely emit the pressure and hygrometry information measured in order to control the state of the air located between the fabric 24 and the aircraft body. Alternatively, the two sensors 202, 203 may be electrically coupled to the electronic control device 201 configured to record the values of this information. Thus, according to the hygrometry and pressure values, it is possible to warn the user who could decide to remove, or keep, the envelope 21 deployed over the aircraft body 1.

According to still another advantage, the protective system 20 comprises an accelerometer 204, as illustrated in FIG. 3, configured to measure a deployment speed of the envelope 21. For example, the accelerometer 204 may be mounted on the fabric 24, preferably on the inner face 26, or on one end of the envelope 21, preferably on the ring 50 of the framework 23. Preferably, the accelerometer is coupled to the electronic control device 201 of the case 82, either directly through a wired connection, or wirelessly. Thus, the electronic control device 201 can control a flow of the fluid injected into the ducts 40 of the framework 23 according to the speed of deployment of the envelope 21, in order to avoid unintentional tearing.

Advantageously, the accelerometer 204 may also be used, when the envelope 21 is deployed, to measure vibrations of the envelope 21 in the event of impacts of external elements against the envelope 21. Thus, the accelerometer 204, also referred to as an impact sensor, allows warning the user of any tearing, for example when the accelerometer 204 measures a speed information higher than or equal to a reference speed corresponding to tearing of the fabric 24 or of the framework 23.

The envelope 21 may further comprise a position sensor 207, for example mounted on the inner face 26 of the fabric 24 or on a duct 40 of the framework 23. As illustrated in FIG. 3, another example has been shown wherein the position sensor 207 is mounted on a ring 51 of the framework 23. Advantageously, the position sensor enables a user to locate the position of his/her aircraft 1, from the position emitted by the position sensor, which facilitates finding an aircraft 1 amongst a set of vehicles, generally parked in hangars and which are not visible from the tarmac. Thus, the protective envelope integrates one or more sensor(s) 202 to 204 and may be configured so as to transmit the information collected by these sensors to a remote terminal. Thus, the envelope is a communicating envelope. The integration of one or more sensor(s) and the ability to transmit the collected information may be used independently of the automatic nature of the deployment of the envelope.

According to another advantage, the envelope 21 may comprise at least one strap 205, 206, as illustrated in FIG. 4, configured to hold the envelope 21 to the aircraft body 1. For example, a strap 205, 206 may comprise a first hook intended to be fastened to the fabric 24, or to the framework 23, and a second hook intended to be fastened to a portion of the aircraft 1, for example to the front landing gear 9. Alternatively, a strap 205, 206 includes two hooks intended to be fastened on the envelope 21, the strap 205, 206 being positioned around the front landing gear 9, or another projecting portion of the aircraft 9, so as to keep the framework 23 in contact with the aircraft 1. Preferably, the length of a strap 205, 206 is adapted so that the strap 205, 206 does not cause impacts against the aircraft 1 in case of wind. According to another example, a strap 205, 206 may be placed movable within a sheath mounted on the envelope 21. In particular, the sheath extends over the outer face 25 of the fabric 24, preferably along a section of a ring 50, 51 of the framework 23, so as to be able to tighten the ring 50, 51 around a portion of the aircraft 1. Tightening of the ring 50, 51 is carried out by adjusting the length of the strap 205, 206 movable within the sheath.

FIGS. 2 to 4, 6 and 7 show the main steps of a method for protecting a portion 2 to 7 of an aircraft body 1. The method may be implemented by the protection system 22 as defined hereinbefore. In particular, the method comprises deploying the envelope 21 so that the fabric 24 of the envelope 21 at least partially covers the portion 2 to 7 of the aircraft body 1. The deployment comprises filling the duct(s) 40 of the framework 23 with a fluid. Prior to the deployment of the envelope 21, the method comprises setting the envelope 21 in the retracted position. The envelope may be accommodated in the retracted position in the case 82. Then, the method comprises positioning the envelope 82 opposite the portion 2 to 7 of the aircraft body 1, for example by placing the case in contact with the portion 2 to 7. Then, the framework 23 is inflated to deploy the envelope 21 in an automated manner. Advantageously, the deployment comprises an extension of the framework 23 according to a generatrix Z, as illustrated in FIG. 2.

1. A protective envelope for a portion of an aircraft body, comprising a framework and a fabric, the fabric being mechanically coupled to the framework and extending around the framework so that, in a deployed configuration of the envelope, the framework enables holding of the fabric, the framework being configured so as to be located between the portion of the aircraft body and an inner face of the fabric so that the fabric could at least partially cover the portion of the aircraft body while keeping the fabric at a distance from the portion of the aircraft body, the framework comprising at least one duct adapted to be filled with a fluid, so that when the conduit is filled with a fluid the envelope deploys so that the fabric at least partially covers the portion of the aircraft body, wherein the framework forms at least one ring, said at least one ring being configured to at least partially surround the portion of the aircraft body when the framework is deployed and wherein said at least one ring is configured to clasp the portion of the aircraft body when the framework is deployed.

2. The envelope according to claim 1, wherein said at least one duct includes a fluid-tight hollow body.

3. The envelope according to claim 1, comprising a plurality of ducts forming a network of branched ducts.

4. The envelope according to claim 1, wherein several ducts are fluidly connected to each other.

5. The envelope according to claim 1, wherein the framework comprises at least one inlet orifice configured to be connected to a deployment system, the deployment system being configured to supply the framework with fluid.

6.-7. (canceled)

8. The envelope according to claim 1, wherein said at least one ring has an outer surface having at least one portion forming, according to a section of said at least one ring, a completely closed continuous contour.

9. The envelope according to claim 1, wherein the framework forms at least two rings, one amongst the two rings having a continuous contour and the other one amongst the two rings having an interrupted contour to form an opening, the opening being carried by the ring located at a distal end of the envelope and is directed opposite the ground when the framework is deployed.

10. The envelope according to claim 1, wherein, said at least one ring is located at least at one of the ends of the envelope.

11.-12. (canceled)

13. The envelope according to claim 1, wherein the fabric comprises a transparent area.

14. The envelope according to claim 1, comprising at least one sensor configured to collect measurements as well as a transmission device configured to transmit data relating to these measurements to a remote terminal, said sensor being taken among a shock sensor, a pressure sensor, a humidity or hygrometry sensor or a position sensor.

15.-16. (canceled)

17. A protective system for a portion of an aircraft body, comprising an envelope according to claim 1, and a deployment system comprising a compression system and a connector, said at least one duct of the envelope comprising an inlet orifice adapted to be connected to the deployment system, the connector being configured to transmit a fluid from an outlet of the compression system up to the inlet orifice so as to fill said at least one duct with the fluid.

18.-20. (canceled)

21. The system according to claim 1, wherein the compression system includes an electromechanical compressor.

22. An assembly comprising an aircraft and an envelope according to claim 1.

23. The assembly according to claim 22, wherein the envelope is configured so as to be supported by a portion of the aircraft body that the fabric covers at least partially, when the envelope is in the deployed configuration.

24. An assembly comprising an aircraft and a system according to claim 17.

25. The assembly according to claim 22 wherein the aircraft comprises at least one probe, for example a pressure probe, and wherein the envelope is configured so that, when the duct is filled with a fluid, the fabric of the envelope deploys without interfering with the probe.

26. The assembly according to claim 22, wherein, in the deployed configuration, the fabric is configured to cover at least 50% of the portion of the aircraft body.

27. (canceled)

28. The assembly according to claim 22, wherein the portion corresponds to a cockpit and/or a wing of an aircraft.

29. (canceled)

30. The assembly according to claim 22, wherein the fabric comprises a transparent area located at a windshield of the aircraft.

31. A method for protecting a portion of an aircraft body, comprising providing an envelope according to claim 1, and deploying the envelope so that the fabric of the envelope at least partially covers the portion of the aircraft body, the deployment comprising filling at least one duct of the framework with a fluid.

32. The method according to claim 31, wherein the deployment is automated.

33. The method according to claim 32, wherein the deployment comprises an extension of the framework according to a generatrix.

34. The assembly according to claim 22, wherein, in the deployed configuration, the fabric is kept at a distance from the portion of the aircraft body comprised between 5 cm and 50 cm.
